(19) United States
(12) Patent Application Publication
(10) Pub. No.: US 2019/0248030 A1
(43) Pub. Date: Aug. 15, 2019

(54) ROBOT ARM MECHANISM

(71) Applicant: LIFE ROBOTICS INC., Tokyo (JP)

(72) Inventors: Hiroaki Matsuda, Tokyo (JP); Woo-Keun YOON, Tokyo (JP)

(21) Appl. No.: 16/393,845

(22) Filed: Apr. 24, 2019

Related U.S. Application Data
(63) Continuation of application No. PCT/JP2017/039106, filed on Oct. 30, 2017.

(30) Foreign Application Priority Data
Oct. 31, 2016 (JP) 2016-213923

(51) Int. Cl. B25J 19/06; B25J 9/16; B25J 13/08

(52) U.S. Cl. CPC B25J 19/063; B25J 13/084; B25J 9/1674

(57) ABSTRACT

A robot arm mechanism has a plurality of link sections. The plurality of link sections are connected by a plurality of joints. The plurality of link sections are respectively covered with covers. The respective covers are supported by push-button switches or pressure sensors. When a worker or the like touches any of the covers, the push button switch or the pressure sensor that supports the cover is turned on. Thereby, contact to any of the covers by the worker or the like is detected. Contact of the worker or the like can be detected in a wide range.

### CROSS-REFERENCE TO RELATED APPLICATIONS

This application is a continuation application of International Patent Application No. PCT/JP2017/039106 filed on Oct. 30, 2017, which claims priority to Japanese Patent Application No. 2016-213923, filed Oct. 31, 2016, the entire contents of which are incorporated by reference.

### FIELD

Embodiments described herein relate generally to a robot arm mechanism.

### BACKGROUND

Conventionally, an articulated robot arm mechanism is used in various fields such as an industrial robot. The linear extension and contraction mechanism that is put to practical use by the inventors can eliminate the need of an elbow joint from a vertical articulated robot arm mechanism, and thereby can eliminate a singular point. The robot arm mechanism like this does not perform abrupt turning movement for avoiding a singular point, and a worker can intuitively grasp the movement of the robot arm mechanism, so that a safety fence is not required. It becomes possible to install the robot arm mechanism in a vicinity of the worker, and an environment in which the robot and the worker cooperate becomes realistic. While the environment where the robot arm mechanism is disposed in the vicinity of the worker becomes realistic, higher safety is required of the cooperation robot. For example, there is the possibility that other workers or the like than the predetermined worker enter the working area of the robot arm mechanism. Persons who are around the robot arm mechanism are unspecified in this way, so that it is desired to load the function of being able to stop the robot arm mechanism in emergency not only by an emergency stop operation by an exclusive remote controller but also by an intuitive operation.

### CITATION LIST

### Patent Literature

Patent Literature 1; Japanese Patent No. 5435679

### SUMMARY OF INVENTION

### Technical Problem

A purpose of the present invention is to enhance safety of a robot arm mechanism.

### Solution to Problem

A robot arm mechanism according to the present embodiment is formed by a link section being supported by a joint, and a cover that covers the link section is supported by a push-button switch or a pressure sensor.

### BRIEF DESCRIPTION OF THE VIEWS OF THE DRAWING

FIG. 1 is a perspective view illustrating an external appearance of a robot arm mechanism according to the present embodiment;

FIG. 2 is a side view of the robot arm mechanism in FIG. 1;

FIG. 3 is a view illustrating an internal configuration of the robot arm mechanism in FIG. 1;

FIG. 4 is a diagram illustrating a configuration of the robot arm mechanism in FIG. 1 by graphic symbol expression;

FIG. 5 is an exploded view illustrating an example of the robot arm mechanism in FIG. 1;

FIG. 6 is a side view illustrating a method for attaching a cover to a push button switch in FIG. 3;

FIG. 7 is a rear view of the robot arm mechanism in FIG. 1;

FIG. 8 is an exploded view illustrating another example of the robot arm mechanism in FIG. 1; and

FIG. 9 is a view illustrating a structure of a robot arm mechanism according to a modified example of the present embodiment.

### DETAILED DESCRIPTION

Hereinafter, a robot arm mechanism according to the present embodiment will be described with reference to the drawings. The robot arm mechanism according to the present embodiment is formed by at least one link section being connected by a joint. In the present embodiment, a robot arm mechanism in which one joint out of a plurality of joints is configured by a linear extension and contraction mechanism will be described as an example, but another type of robot arm mechanism may be adopted. The present embodiment also can be applied to a single-axis robot arm mechanism in which a fixed section of a rotation joint is attached to a wall surface, and an arm (link section) is attached to a rotating section of the rotation joint, for example. In the following explanation, components having substantially same functions and configurations will be assigned with same reference signs and redundant explanation will be performed only when necessary.

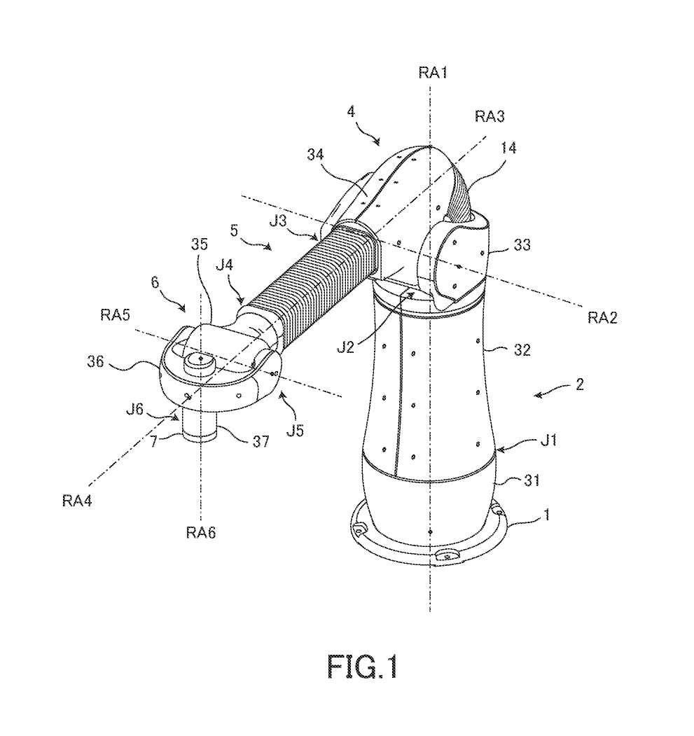

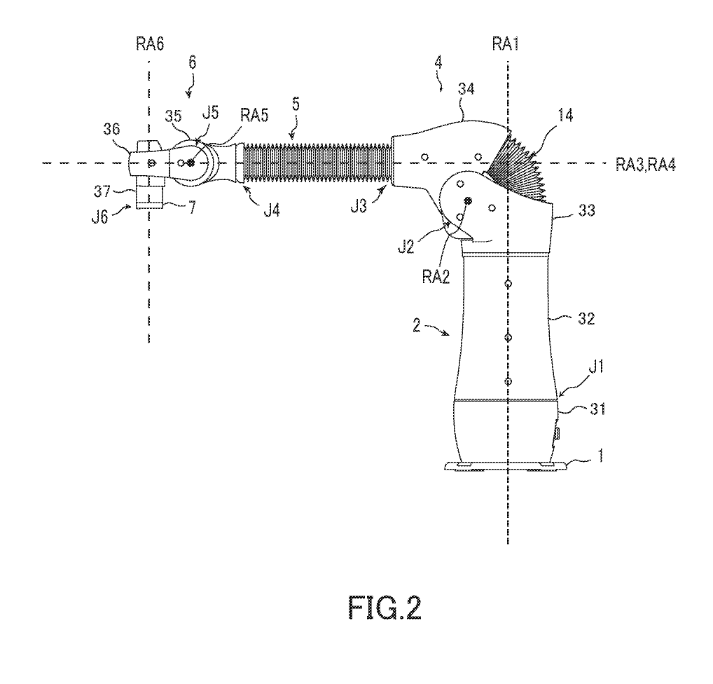

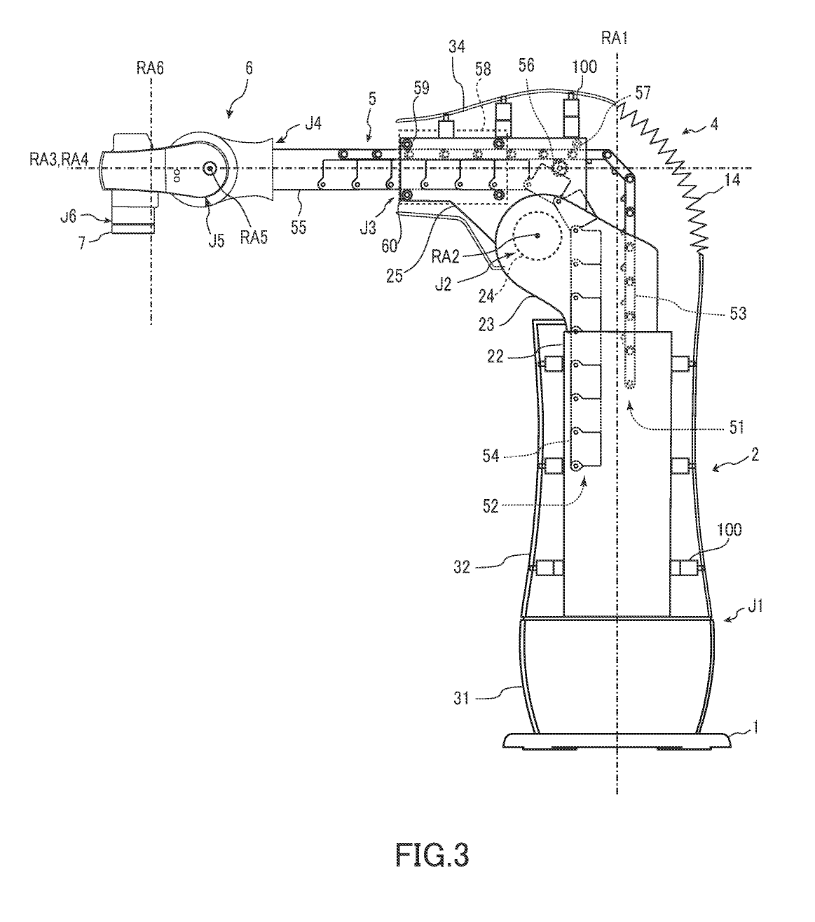

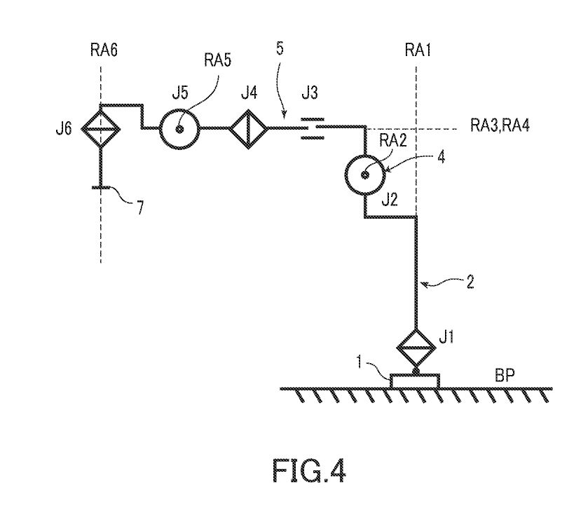

FIG. 1 and FIG. 2 are external views of the robot arm mechanism of a polar coordinates type according to the present embodiment. FIG. 3 illustrates an internal structure of a linear extension and contraction mechanism. FIG. 4 expresses the robot arm mechanism in FIG. 1 by graphic symbols. The robot arm mechanism has a plurality (herein, six) of joints J1, J2, J3, J4, J5 and J6. The plurality of joints J1, J2, J3, J4, J5 and J6 are arranged in order from a base 1. In general, a first joint J1, a second joint J2 and a third joint J3 are called root three axes, and a fourth joint J4, a fifth joint J5 and a sixth joint J6 are called wrist three axes that mainly change a posture of an end effector (end effector). At least one of the joints J1, J2 and J3 that configure the root three axes is a linear extension and contraction mechanism. Here, the third joint J3 is configured as the linear extension and contraction mechanism.

A support column section 2 forming a substantially cylindrical body is installed on the base 1 of the robot arm mechanism. The support column section 2 is separated vertically, and a lower frame 21 at a support column lower portion and an upper frame 22 of a support column upper portion are connected at the first joint J1. The lower frame 21 and the upper frame 22 are respectively covered with cylindrical rigid resin covers 31 and 32. The first joint J1 is a rotation joint rotating on a first axis of rotation RA1 perpendicular to a ground plane of the base 1. The lower frame 21 is connected to a fixed section of the first joint 1. The upper frame 22 is connected to a rotating section of the first joint J1. The arm section 5 turns horizontally by rotation of the first joint J1.

In an internal hollow of the upper frame 22 of the support column upper portion forming the cylindrical body, a first piece string 51 and a second piece string 52 of the third joint J3 that will be described later are stored. A rising and lowering section 4 that stores the second joint J2 is installed on the support column section 2. The second joint J2 is a joint rotating on a second axis of rotation RA2 which is disposed perpendicular to the first axis of rotation RA1. The rising and lowering section 4 has a pair of side frames 23 as a fixed section of the second joint J2. The pair of side frames 23 are covered with a saddle-shaped rigid resin cover 33. The pair of side frames 23 are connected to the upper frame 22. A cylindrical body 24 as a rotating section of the second joint J2 which also serves as a motor housing is supported by the pair of side frames 23. A support section (feeding mechanism) 25 is attached to a circumferential surface of the cylindrical body 24. A frame constituting the feeding mechanism 25 supports a roller unit 58, a drive gear 56, and a guide roller 57. The frame constituting the feeding mechanism 25 is covered with a cylindrical rigid resin cover 34. A U-shaped bellows cover 14 which is U-shaped in section which follows a rising and lowering motions of the rising and lowering section 4 is fitted to between the cover 33 and the cover 34.

The feeding mechanism 25 supports the first and second piece strings 51 and 52 movably back and forth, brings first and second pieces 53 and 54 into contact with each another when the first and second piece strings 51 and 52 move forward, and separates the first and second pieces 53 and 54 when the first and second piece strings 51 and 52 are pulled backward. The arm section 5 rises and lowers vertically by rotation of the second joint J2.

A linear extension and contraction mechanism that forms the third joint J3 includes a structure newly developed by the inventors, and is clearly distinguished from a conventional solid linear motion joint having a limited linear motion range and including a pulling range of the same length as the linear motion range. The third joint J3 is the linear extension and contraction mechanism in which the arm section 5 extends and contracts linearly along a third axis (axis of movement) RA3 that is disposed perpendicularly to the second axis of rotation RA2. By the third joint J3, the arm section (columnar body) 5 extends and contracts back and forth in a state keeping linear rigidity along the third axis of movement RA3.

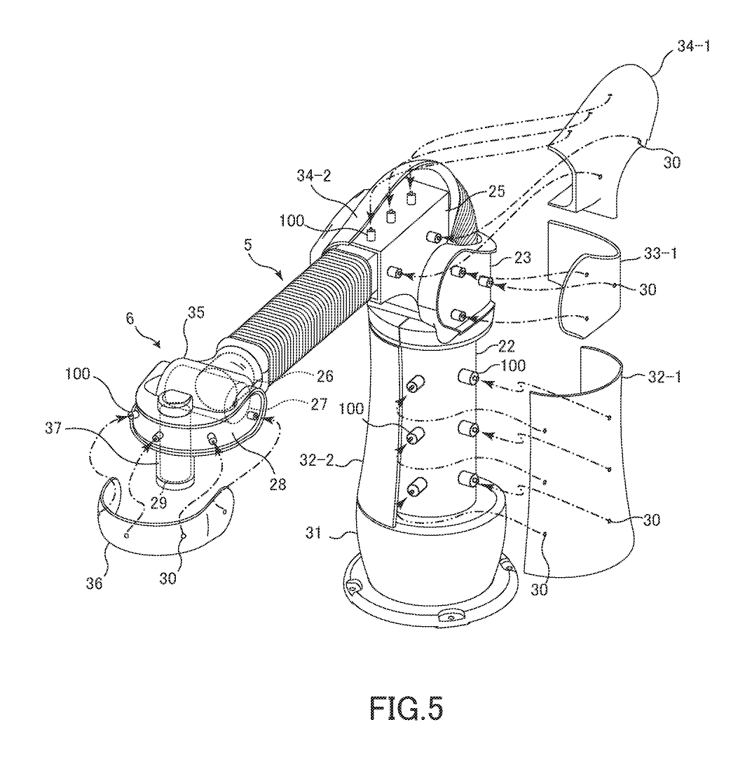

The arm section 5 has the first piece string 51 and the second piece string 52. The first piece string 51 is constituted of a plurality of first pieces 53 which are bendably connected. As illustrated in FIG. 5, the first piece 53 is typically formed into a shape of a substantially flat plate. The first piece 53 is not limited to a flat plate shape, but may be a cylindrical body, and a cross-sectional shape thereof is not limited to a U-shape, and a quadrangle (rectangle), but may be a polygonal shape such as a triangle and a pentagon, or further a circle, an oval, or a circular-arc shape with a part of a circle or an oval being cut out. Here, the first piece 53 is described as being formed into a substantially flat plate shape.

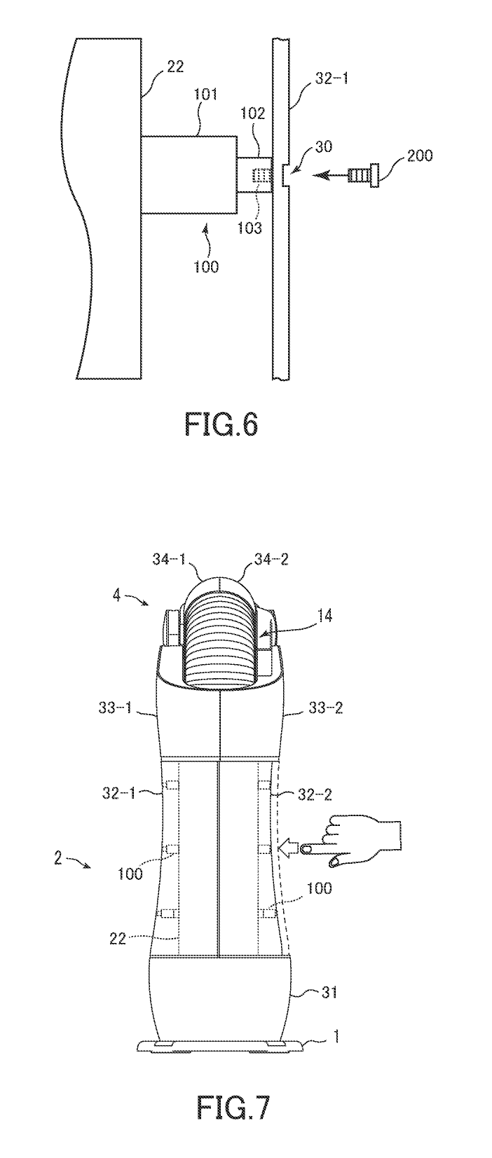

The second piece string 52 is constituted of a plurality of second pieces 54 that are bendably connected. The second piece 54 typically forms a cylindrical body U-shaped in section in which a front side is opened as illustrated in FIG. 6. The second piece 54 is not limited to the cylindrical body U-shaped in section, but other cylindrical bodies having various cross-sectional shapes can be adopted. For example, the second piece 54 may be a cylindrical body quadrangular in section. The second piece 54 forms a cylindrical body, and a cross-sectional shape thereof is not limited to a quadrangle (rectangle), but may be a polygonal shape such as a triangle and a pentagon, or further a circle, an oval, or a circular-arc shape with a part of a circle or an oval being cut out. Here, the second piece 54 is described as being formed into a cylindrical body U-shaped in section.

As described layer, the first piece 53 and the second piece 54 are brought into contact with each other. An entire shape of a cross section in a state where the first piece 53 and the second piece 54 are in contact with each other under the respective shapes of the first piece 53 and the second piece 54 described above forms a quadrangle, a triangle, a rhombus, a trapezoid, other polygons, an H-shape, a circle or an oval.

The second pieces 54 are bendably connected on bottom plates. Bend of the second piece string 52 is restricted in a position where end surfaces of side plates of the second pieces 54 abut on each other. In that position, the second piece string 52 is arranged linearly. The leading first piece 53 of the first piece string 51 and the leading second piece 54 of the second piece string 52 are connected by a head piece 55.

The head piece 55 is a block having a shape in which an upper portion thereof protrudes more rearward than a lower portion. A protruding length of the upper portion to the lower portion is a length that is half the length of the second piece 53. The upper portion has a same thickness as the first piece 53, and the lower portion has a same thickness as the second piece 54. The leading first piece 53 is bendably connected to the upper portion, and the leading second piece 54 is bendably connected to the lower portion. A connecting position of the first pieces 53 shifts by ½ length with respect to a connecting position of the second pieces 54. An opening and closing position (connecting position) of the front and rear second pieces 54 is located in a longitudinal center of the first piece 53. A lock mechanism which will be described later is fitted in this position.

The first and second piece strings 51 and 52 are pressed by an upper and lower rollers 59 of a support section (roller unit 58) 58 in a rectangular tube shape and are brought into contact with each other. The first and second piece strings 51 and 52 which are in contact with each other constitute the columnar arm section 5. When the first and second pieces 53 and 54 respectively have the aforementioned typical cross-sectional shapes, the first and second pieces 53 and 54 become rigid by being in contact with each other and form a linear columnar body. However, when planar shapes of the first and second pieces 53 and 54 are trapezoidal shapes or partial shapes of an annular shape, the first and second pieces 53 and 54 become rigid by being in contact with each other to form a curved columnar shape.

A drive gear (pinion) 56 is provided behind a string of the rollers 59. The drive gear 56 is connected to a motor not illustrated via a decelerator. A linear gear is provided in a front and back direction in a center of a width of an inner wall of the first piece 53. When the plurality of first pieces 53 are linearly lined up, the front and rear linear gears are connected linearly to constitute a long linear gear (rack). The drive gear (pinion) 56 is meshed with the linear gear in a straight line. The linear gears which are linearly connected constitute a rack and pinion mechanism with the drive gear 56. When the drive gear 56 rotates forward, the arm section 5 extends forward. When the drive gear 56 rotates reversely, the arm section 5 is pulled back to an inside of the rising and lowering section 4 and contracts. The first and second piece strings 51 and 52 which are pulled back to behind the support section 58 and are released from compression by the upper and lower rollers 59 are separated from each other. The first and second piece strings 51 and 52 which are separated return to a bendable state respectively. The first and second piece strings 51 and 52 which return to the bendable state bend in a same direction (bottom plate side of the second piece 54) together in the rising and lowering section 4, and are stored inside the support column section 2. At this time, the first piece string 51 is stored in a state substantially parallel to the second piece string 52.

A wrist section 6 is attached to a tip end of the arm section 5. The wrist section 6 is equipped with a fourth to sixth joints J4 to J6. The fourth to sixth joints J4 to J6 respectively include axes of rotation RA4 to RA6 of the orthogonal three axes. The fourth joint J4 is a rotation joint rotating on the fourth axis of rotation RA4 which substantially corresponds to the axis of extension and contraction RA3, and the end effector is swingably rotated by rotation of the fourth joint J4. The fifth joint J5 is a rotation joint rotating on the fifth axis of rotation RA5 that is disposed perpendicularly to the fourth axis of rotation RA4, and the end effecter is tilted and rotated back and forth by rotation of the fifth joint J5. The sixth joint J6 is a rotation joint rotating on the sixth axis of rotation RA6 that is disposed perpendicularly to the fourth axis of rotation RA4 and the fifth axis of rotation RA5, and the end effector is axially rotated by rotation of the sixth joint J6.

The head piece 55 of the arm section 5 is connected to the fixed section of the fourth joint J4. To the rotating section of the fourth joint J4, a cylindrical frame 26 with the fourth axis of rotation RA4 as the center line is connected. A cylindrical body 27 as the fixed section of the fifth joint J5 with the fifth axis of rotation RA5 as the center line is supported at a tip end of the frame 26. The cylindrical body 27 is also used as the housing of the motor that drives the fifth joint J5, and the motor main body is fixed inside the cylindrical body 27. The cylindrical frame 26 and the cylindrical body 27 are covered with a rigid resin cover 35. The cover 35 is a cover formed by integrally molding a cylindrical cover with the fourth axis of rotation RA4 as the center axis and a cylindrical cover with the fifth axis of rotation RA5 as the center axis, and causing interiors to communicate with each other. A U-shaped frame 28 is attached to a rotating shaft of the motor which drives the fifth joint J5 in a state straddling both ends of the cylindrical body 27. The U-shaped frame 28 is covered with a U-shaped rigid resin cover 36. A cylindrical body 29 forming a fixed section of the sixth joint J6 is attached to an inside of a tip end of the U-shaped frame 28. The cylindrical body 29 is covered with a cylindrical rigid resin cover 37. The U-shaped cover 36 and the cylindrical cover 37 are integrally molded and interiors thereof communicate with each other.

An adapter 7 for connecting the end effector (end effector) to the rotating section of the sixth joint J6 is provided at a lower part of the cylindrical body 29. The end effector is a portion for the robot to have a function of directly working on an object to be worked (work), and various tools exist in accordance with tasks, such as a grasping section, a vacuum suction section, a nut fastening tool, a welding gun, and a spray gun, for example. The end effector is moved to an arbitrary position by the first, second and third joints J1, J2 and J3, and is disposed in an arbitrary posture by the fourth, fifth and sixth joints J4, J5 and J6. In particular, a length of extension and contraction distance of the arm section 5 of the third joint J3 enables the end effector to reach objects in a wide range from a proximity position to a remote position of the base 1. Characteristic points of the third joint J3 which are different from the conventional linear motion joint are the linear extension and contraction motion and the length of the extension and contraction distance which are realized by the linear extension and contraction mechanism constituting the third joint J3.

FIG. 4 illustrates the configuration of the robot arm mechanism by graphic symbol expression. In the robot arm mechanism, three position freedom degrees are realized by the first joint J1, the second joint J2 and the third joint J3 which constitute the root three axes. Further, three posture freedom degrees are realized by the fourth joint J4, the fifth joint J5 and the sixth joint J6 which constitute the wrist three axes. As illustrated in FIG. 4, the axis of rotation RA1 of the first joint J1 is provided in the vertical direction. The axis of rotation RA2 of the second joint J2 is provided in the horizontal direction. The first joint J1 and the second joint J2 are connected by a first link section. The first link section is configured by the upper frame 22 and the pair of side frames 23. By the first link section, the second joint J2 is offset concerning two directions of the axis of rotation RA1 and an axis orthogonal to the axis of rotation RA1 with respect to the first joint J1. The axis of rotation RA2 of the second joint J2 does not intersect the axis of rotation RA1 of the first joint J1.

The axis of movement RA3 of the third joint J3 is provided in an orientation perpendicular to the axis of rotation RA2. The second joint J2 and the third joint J3 are connected by a second link section. The second link section is configured by a frame of the feeding mechanism 25. By the second link section, the third joint J3 is offset concerning two directions of the axis of rotation RA1 and the axis orthogonal to the axis of rotation RA1 with respect to the second joint J2. The axis of rotation RA3 of the third joint J3 does not intersect the axis of rotation RA2 of the second joint J2. The third joint J3 and the fourth joint J4 are connected by a third link section. The third link section is configured by the arm section 5 including extension and contraction property of the linear extension and contraction joint. By the third link section, the fourth joint J4 is disposed on a same straight line as the third joint J3. The fourth joint J4 and the fifth joint J5 are connected by a fourth link section. The fourth link section is configured by the cylindrical frame. By the fourth link section, the fifth joint J5 is disposed on a same straight line as the fourth joint J4. The fifth joint J5 and the sixth joint J6 are connected by a fifth link section. The fifth link section is configured by the U-shaped frame and the cylindrical body inside the tip end of the U-shaped frame. By the fifth link section, the sixth joint J6 is offset concerning two directions of the axis of rotation RA4 and an axis orthogonal to the axis of rotation RA5.

The robot arm mechanism of the robot device according to the present embodiment structurally eliminates the singular point posture by replacing the one joint of the root three axes of the plurality of joints J1 to J6 with the linear extension and contraction joint J3, offsetting the second joint J2 in the two directions with respect to the first joint J1, and offsetting the third joint J3 in the two directions with respect to the second joint J2.

In the robot arm mechanism according to the present embodiment, the cover that covers at least one link section of the plurality of link sections are supported by push-button switches 100. The push-button switches 100 are installed on an outer surface of the link section. In the present embodiment, the covers 32 and 33 that cover the first link section, the cover 34 that covers the second link section, and the cover 36 that covers the fifth link section are respectively supported by the push-button switches 100. A type of the push-button switch 100 is preferably a momentary type that keeps an on state only while an operation section (a movable section, a reciprocating section or the like) 102 described later is pushed down. Thereby, a return operation of returning the push-button switch 100 which is pushed down to an original state can be made unnecessary. The type of the push-button switch 100 may be an alternate type that keeps an on state when pushing down the switch 100, and returns the switch 100 to the original state by further pushing down the switch 100 again.

The push button switch 100 has a cylindrical main body section 101. In the main body section 101, a movable section 102 having a columnar shape is movably inserted in an axial direction thereof. The movable section 102 is urged in a direction (urging direction) in which the movable section 102 is pushed out from the main body section 101 by urging means such as a spring not illustrated. The movable section 102 is pushed into the main body section 101 against an urging force. In the push-button switch 100, a bottom portion of the main body section 101 is installed on the link section so that the axial direction of the movable section 102 is perpendicular to the surface of the link section. In a tip end surface of the movable section 102, a screw hole 103 for attaching the cover is opened. In the main body section 101, a switch section and a switch detection circuit that detects opening and closing of the switch section are stored in a casing. When the movable section 102 is pushed in by a predetermined distance, the switch section is closed. The switch detection circuit outputs a signal (referred to as an on signal) showing that the switch section is closed when the switch section is closed. When the movable section 102 is released, the switch section is switched into an open state. The switch detection circuit does not output the on signal when the switch section is in the open state. Alternatively, a signal (referred to as an off signal) showing that the switch section is in the open state, an off signal for convenience of explanation herein is outputted. The on/off signal which is outputted from the switch detection circuit is sent to a control section of the robot device, for example. The control section of the robot device executes emergency stop control of stopping the robot arm mechanism with reception of the on signal indicating that the push-button switch 100 being turned on as an impetus.

The main body section 101 of the push-button switch 100 is provided with a mounting section for attaching the push-button switch 100 into a predetermined position. The push-button switch 100 is attached to each of the link sections via the mounting section. The mounting section includes a height adjustment mechanism for adjusting a height to the movable section 102 from the bottom portion of the push-button switch 100, for example. A load exerted on the movable section 102 of each of a plurality of push-button switches 100 can be uniformly dispersed even when the cover is supported by the plurality of push-button switches 100 by adjusting the height of the mounting section in accordance with the distance between the cover and the link section.

In the covers 32, 33, 34 and 36, screw holes 30 for attaching to the movable sections 102 of the push-button switches 100 are opened. As illustrated in FIG. 6, for example, the cover 32 is fastened to the movable section 102 by a screw 200 in a state where each of the screw holes 30 is positioned to the screw hole 103 of the movable section 102 of the push-button switch 100.

The cover 32 in the cylindrical shape that covers the upper frame 22 which configures the first link section is divided into two cover sections 32-1 and 32-2 each in a half cylinder shape. A plurality of push-button switches 100 are disposed on the surface of the upper frame 2 with center axes thereof being in directions orthogonal to the axis of rotation RA1. The respective two cover sections 32-1 and 32-2 are supported by the plurality of push-button switches 100 which are disposed on the upper frame 22.

Likewise, the U-shaped cover 33 which covers the side frame 23 configuring the first link section is laterally divided into two cover sections 33-1 and 33-2. A plurality of push-button switches 100 are disposed on surfaces of the pair of side frames 23 with center axes thereof being in an orientation orthogonal to the axis of rotation RA1. The respective two cover sections 33-1 and 33-2 are supported by the plurality of push-button switches 100 which are disposed on the side frames 23.

The cylindrical cover 34 that covers the frame of the feeding mechanism 25 that configures the second link section is divided into two cover sections 34-1 and 34-2. A plurality of push-button switches 100 are disposed on the frame of the feeding mechanism 25 with center axes thereof being in an orientation orthogonal to the axis of extension and contraction RA3, for example. The respective two cover sections 34-1 and 34-2 are supported by the plurality of push-button switches 100 which are disposed on the frame of the feeding mechanism 25.

The U-shaped cover 36 that covers the U-shaped frame 28 configuring the fifth link section is supported by a plurality of push-button switches 100 which are disposed on the U-shaped frame 28. The plurality of push-button switches 100 are disposed on the U-shaped frame 28 with center axes thereof being in an orientation orthogonal to the axis of rotation RA6.

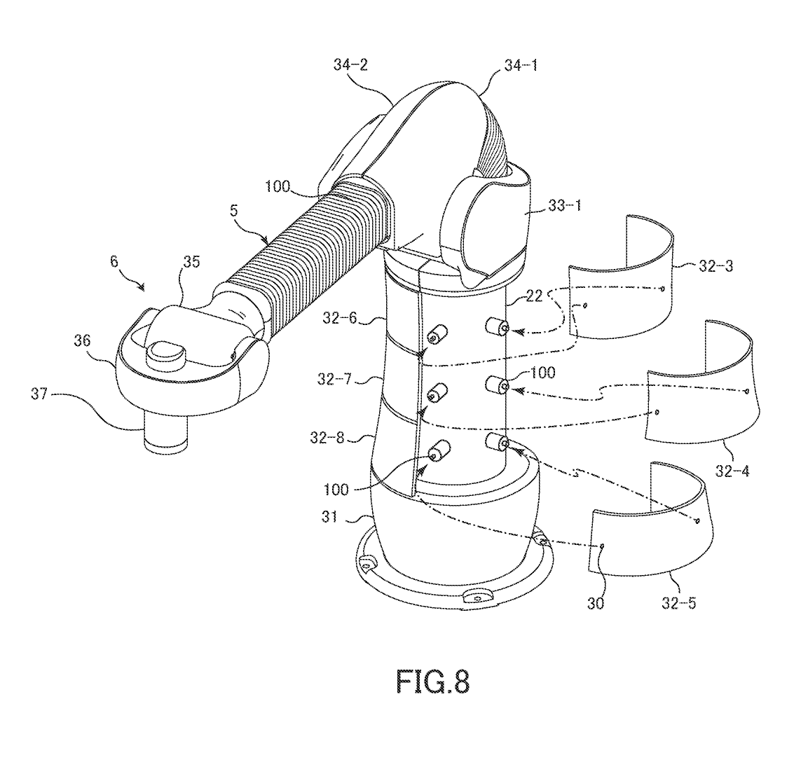

As described above, by supporting the rigid resin covers 32, 33, 34 and 36 of the robot arm mechanism respectively by the push-button switches 100, these covers 32, 33, 34 and 36 can be caused to function as the movable sections 102 of the push-button switches 100. That is, even with a small number of push-button switches 100, a range in which a pushing operation is enabled by the worker can be enlarged. Here, the covers that are caused to function as the movable sections 102 of the push-button switches 100 are described as the covers 32, 33, 34 and 36, but the other covers 31, 35 and 37 may be supported with the push-button switches 100 respectively, and may be caused to function as the movable sections 102 of the push-button switches 100. Further, the cover 32 that covers the upper frame 22 is divided into two as illustrated in FIG. 5 and the respective cover sections 32-1 and 32-2 are supported by the push-button switches 100 herein, but as illustrated in FIG. 8, the cover 32 may be divided into six, and respective cover sections 32-3, 32-4, 32-5, 32-6, 32-7 and 32-8 may be supported by push-button switches 100, and may be caused to function as the movable sections 102 of the push-button type switches 100. By increasing the number of divisions of the cover, and making the cover sections small, a force for pushing down the cover can be reduced as compared with the case where the cover section is large, and easiness in pushing down the cover by the worker or the like is enhanced. Further, by increasing the number of divisions of the cover, pushing-down positions of the robot arm mechanism can be finely specified. The control section of the robot device may change control of the robot arm mechanism in response to the specified pushing-down position. For example, when a plurality of cover sections are pushed down simultaneously, the control section of the robot device may execute emergency stop control of stopping the robot arm mechanism, and when the single cover section is pushed down, the control section of the robot device may execute deceleration control of making the movement of the robot arm mechanism slow.

Further, each of the covers may be given a similar function as an operation button (including an emergency stop button) included in the conventional pendant. Thereby, many and unspecified workers who do not possess a pendant can easily operate the robot arm mechanism.

In the conventional robot device, the pendant for operating the robot arm mechanism is equipped with an emergency stop button, for example, or an emergency stop button is disposed in a predetermined position. In the robot arm mechanism according to the present embodiment, workers are assumed to be included in the working area. For example, when a plurality of workers are working in the working area of the robot arm mechanism, preparing the pendant equipped with the emergency stop button for each of these workers is not realistic for the reason of cost increase or the like. Further, since the safety fence is not required, many and unspecified persons are likely to enter the working area of the robot arm mechanism, and it is difficult to causes the workers who enter the working area to carry the pendants each time. When the emergency stop button is disposed in the predetermined position, the worker needs to stop working and move to the position where the emergency stop button is disposed to push the emergency stop button, and the robot arm mechanism may be broken significantly within the moving time period. Further, in a state where the robot arm mechanism is in contact with a worker, the worker may not be able to move to the position where the emergency stop button is disposed.

The robot arm mechanism according to the present embodiment realizes to make the covers themselves which cover the main components of the robot arm mechanism function as the movable sections 102 of the push-button switches 100. Thereby, as illustrated in FIG. 7, the worker or the like who is in the vicinity of the robot arm mechanism can stop the robot arm mechanism in emergency by pushing down the cover 32-2. Accordingly, the workers and the like only have to touch the cover of the robot arm mechanism when the workers and the like desire to stop the robot arm mechanism, and the operation is intuitive and easy to understand. Thereby, possession of the pendant of each of the persons who enter the working area of the robot arm mechanism is made unnecessary, and even in the state where the robot arm mechanism is in contact with a worker, the worker can stop the robot arm mechanism by pushing down the cover of the robot arm mechanism. That is, according to the robot arm mechanism according to the present embodiment, safety can be enhanced.

### Modified Example

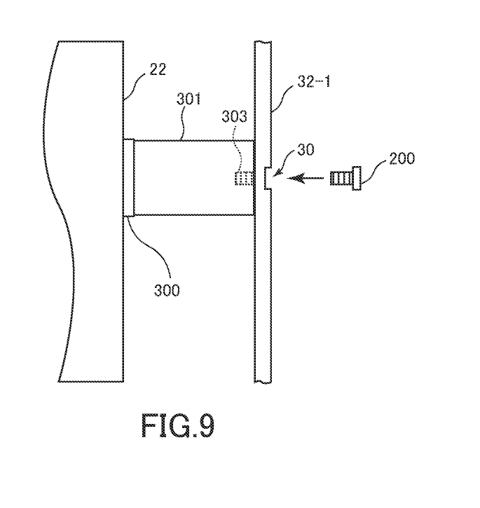

FIG. 9 is a view illustrating a structure of a robot arm mechanism according to a modified example of the present embodiment. In the robot arm mechanism according to the modified example, a cover that covers at least one link section of a plurality of link sections is supported by a pressure sensor. As illustrated in FIG. 9, the pressure sensor has a piezoelectric sheet (a polymer thick film or the like) 300 in a sheet shape. When an external force is applied to the piezoelectric sheet 300, the sheet deforms, and an electric resistance value in that portion changes. The piezoelectric sheet 300 outputs a voltage signal corresponding to the electric resistance value to a determination circuit of the pressure sensor. The determination circuit detects that a cover described later is pushed down by a voltage value sent from the piezoelectric sheet 300 becoming a predetermined value or more. The piezoelectric sheet 300 is disposed on an inner surface of a bottom plate of a shallow box-shaped case 13. A rear end surface of a columnar sponge 301 is bonded onto a surface of the piezoelectric sheet 300 by an adhesive or the like. A metal screw hole 303 is fitted onto a tip end surface of the sponge 301. As illustrated in FIG. 9, for example, the cover 32-1 is fitted by a screw 200 in a state where a screw hole 30 is positioned to the screw hole 303 of the sponge 301, for example. A cushioning member such as a sponge 302 is interposed between the piezoelectric sheet 300 and the cover 32-1, whereby the force which pushes down the cover 32-1 can be prevented from being directly transmitted to the piezoelectric sheet 300, and thereby a damage or the like of the piezoelectric sheet 300 can be suppressed.

As described above, by supporting the cover of the robot arm mechanism by the piezoelectric sheet 300, the cover itself can be caused to function as the movable section of the switch, and thereby the robot arm mechanism according to the modified example of the present embodiment can enhance safety.

Besides above description, as the sensor that supports the cover, a photoelectric sensor device may be adopted, for example. The photoelectric sensor device has a light projecting section and a light receiving section. The light projecting section and the light receiving section are disposed to face a bottom surface of the case 13. The light projecting section and the light receiving section including optical paths thereof are covered with a cushioning member that transmits light such as urethane sponge. The cover of the robot arm mechanism is fitted to the urethane sponge with a screw, an adhesive or the like. The light receiving section outputs a voltage signal corresponding to a light reception amount to the determination circuit. When an external force is applied to the urethane sponge, density of the urethane sponge becomes high. Thereby, the light amount received by the light receiving section reduces as compared with the light amount at a time of no external force being applied to the urethane sponge. The determination circuit detects pressing-down of the cover by the voltage value sent from the light receiving section being a predetermined value or less. As described above, by supporting the cover of the robot arm mechanism by the photoelectric sensor device, the cover itself can be caused to function as the movable section of the switch, and thereby the robot arm mechanism according to the modified example of the present embodiment can enhance safety.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

5 . . . Arm section, 6 . . . Wrist section, 22, 23, 24, 25, 26, 27 . . . Frame, 30 . . . Screw hole, 31, 32, 33, 34, 35, 36, 37 . . . Cover, 100 . . . Push-button switch

1. A robot arm mechanism formed by a link section being supported by a joint,
wherein the link section is covered with a cover, and
the cover is supported by a push-button switch or a pressure sensor.

2. The robot arm mechanism according to claim 1,
wherein the cover is divided into a plurality of cover sections, and each of the plurality of cover sections is supported by the push-button switch or the pressure sensor.

3. The robot arm mechanism according to claim 1,
wherein the cover is a rigid cover.

4. The robot arm mechanism according to claim 1,
wherein the push-button switch is of a momentary type.

5. A robot arm mechanism in which a support column section including a turning rotation joint is supported on a base, a rising and lowering section including a rising and lowering rotation joint is placed on the support column section, a linear extension and contraction joint including an arm with a linear extension and contraction property is provided on the rising and lowering section, a wrist section to which an end effector is fittable is equipped at a tip end of the arm, a swing rotation joint for swingably rotating the end effector, a tilting rotation joint for tilting and rotating the end effector back and forth, and an axial rotation joint for axially rotating the end effector are combined in the wrist section, the turning rotation joint and the rising and lowering rotation joint are connected by a first link section, the rising and lowering rotation joint and the linear extension and contraction joint are connected by a second link section, the linear extension and contraction joint and the swing rotation joint are connected by a third link section including the arm, the swing rotation joint and the tilting rotation joint are connected by a fourth link section, and the tilting rotation joint and the axial rotation joint are connected by a fifth link section,
wherein a cover that covers at least one link section of the first, second, third, fourth and fifth link sections is supported by a push-button switch or a pressure sensor.
